(19) United States
(12) Patent Application Publication
(10) Pub. No.: US 2023/0029412 A1
(43) Pub. Date: Jan. 26, 2023

(54) PORTABLE PET HYDRATION STATION

(71) Applicant: JACOB GOODIN, WILMINGTON, NC (US)

(72) Inventor: JACOB GOODIN, WILMINGTON, NC (US)

(21) Appl. No.: 17/383,920

(22) Filed: Jul. 23, 2021

(51) Int. Cl. A01K 7/00

(52) U.S. Cl. CPC A01K 7/005

(57) ABSTRACT

A portable watering station with a base, a bowl and a telescoping lid that fits over the opening of the bowl. The stand is an elongated structure that is sized and shaped to fit into a standard size cup holder in a passenger vehicle. The stand can be hollow or partially hollow and the bottom of the cup may be open to the hollow section of the stand. The telescoping lid is convex or curved structure that has multiple segments that slide into or underneath one another so that the lid can be opened in stages. The lid can be fully opened to allow a pet free access to the water in the water receptacle, but it can also be partially opened such that the lid can act as a back splash.

### BACKGROUND OF THE INVENTION

### (a) Field of the Invention

The present invention is in the technical field of pet accessories. More particularly, the present invention is in the technical field of portable watering stations for devices for pet owners.

### (b) Background Art

Between 2017 and 2018, roughly 38% of all American households owned at least one dog and approximately 25% of all U.S. households owned a cat¹. As a result, there is a very large market for pet accessories. People increasingly like to take their pets out in public with them for a variety of activities and as a result, there are several products for sale that are marketed towards pet owners as portable watering stations for dogs and cats. Such devices allow pet owners to travel with their pets and while tending to their basic needs. However, most of the devices meant to be portable watering stations for cats and dogs are ill equipped to be used in a vehicle. As a result, the inventor of the presently disclosed device has created a portable hydration station for pets that fits into the standard cup holder of a motor vehicle. ¹ Source: U.S. Pet Ownership & Demographics Handbook

One of the more common portable pet hydration stations already on the market consists of a storage container with a modified cup at the end of it separated by a wall containing a hand activated valve. The storage container can be filled with water and then with the push of a button, the user can open the valve, tilt the device such that the cup is lower than the storage container allowing water to drain from the storage container into the cup, which the user then has to hold out for their pet to drink from. This same device allows the user to drain the water back into the device by opening the valve and tilting the device to allow the water to run back into the storage container from the cup. However, this device has several notable drawbacks. First, this device is meant to be used as a hand-held watering station for a pet and must be held or supported by hand while the pet drinks out of it. Second, this device is not usable when/if it is stored vertically. If the storage device is shaped properly, it could be stored in a vehicle cup holder, but would not be suitable for use as the cup is oriented such that the device cannot be used when it is vertical. Third, since the device uses an ice cream scoop shaped cup which means there is no means to store water in the cup when the device is not in use. Fourth, users report that the operation of the valve is difficult.

Another similar device consists of a vertically oriented storage container connected to a horizontally-oriented funnel shaped bowl with a tube or straw. When the storage container is squeezed, it forces water through the straw or tube into the funnel shaped bowl. However, this device has some of the same drawbacks that the other devices do, namely, that the device must be held in one's hand to be used. The container must be squeezed to force water into the device. When pressure on the storage container is released, water flows through the tube or straw back into the container as long as the container is held up right. In addition, the funnel shaped bowl presents another problem—mess. The more the pet has to reach their snout into the water bowl to drink, the less water gets splashed by the pet outside of the bowl. This is why traditional water bowls are not funnel shaped, but indeed have a large horizontal surface at the bottom of the bowl with flared sides at the edges.

A third set of devices is exemplified by a device made by Heininger which consist of a large horizontally oriented base that contains a few quarts of water and is fitted with a bowl that has a perforated bottom and/or side walls. The bowl is fitted into the horizontally oriented base such that when the base is filled with water, the water level rises above the perforations and thus, the bowl is “filled” with water which the pet can drink. However, this device has its own set of drawbacks. First, while the device is said to hold a few quarts of water, there is nothing that stops the water from draining out of the bowl back into the base. As a result, the vast majority of the water cannot be accessed by the pet as once the pet has drunk enough water to lower the water level below the level of the bottom of the bowl, then the water level is no longer high enough for the pet to reach it. The other alternative is to make the bowl deep enough to reach the bottom of the storage container. If that is done, then the animal will be able to drink most or all of the water out of the storage container thereby leaving it empty. The weight of the water in the container is meant to hold the base of the device in place as it is too large to do anything other than lay flat on the floorboard of a vehicle. In addition, the size of the device and the weight of the water in the device when it is full makes it less portable.

As a result, there is a need for an improved portable watering station for pets that solves the problems above. More specifically, the presently disclosed device is a portable watering station for a pet that is designed to be used on a substantially flat surface or in a cup holder and does not need to be held in a user's hand while the animal drinks. In addition, the device is suitable for storing water for later use and does not have to depend on the weight of the water to hold the device in place. Moreover, there is a need for a device that can reduce the mess associated with pets drinking from the device. As will be seen below, the inventor of the presently disclosed device has created a portable watering station that solves the above problems.

### BRIEF SUMMARY OF THE INVENTION

The present invention is a pet accessory, specifically, a pet accessory that serves as a portable watering station. The device has a stand, a cup or bowl and a telescoping lid that fits over the opening of the cup or bowl. The stand is an elongated structure that extends away from and attaches to the bottom of the water receptacle. The stand in particular is the portion of the device that is anticipated to be sized and shaped to fit into a standard size cup holder in a passenger vehicle. The stand can be made of nearly any material that is durable enough to form a structure that will stay in place in a cup holder. Moreover, the stand can either be a hollow structure or a solid structure depending on how much someone wants the device to weigh. In addition, the stand can be a structure that is similar to a cylinder that is hollow in the center but has thick walls to give the device more weight. In addition, if the stand is hollow, the hollow space in the stand can be used to store additional water if desired. However, it is important to note that the shape of the device allows it to sit stably on a flat surface or in a cup holder and the device can do so whether it contains water or not. In other words, the device does not depend on the weight of the water to hold it in position.

In addition to the stand, the device features a cup or bowl. For simplicity, the cup or bowl will simply be referred to as the water receptacle. The water receptacle can have nearly any desired shape, but preferred embodiments of the water receptacle are shaped like a standard pet food bowl with a flat, horizontal surface and flared sides; although, some embodiments may vary this basic shape with sides perpendicular to the bottom surface of the water receptacle for example. The water receptacle can be operably connected to the stand or the two can be completely sealed off from each other. In other words, the stand can be hollow or partially hollow and the bottom of the water receptacle may be open to the hollow section of the stand depending on how much space for water is desired.

The device also features a telescoping lid that is convex or curved or rounded outward like the exterior of a sphere or circle. In this case, curved outward means the rounded portion of the lid extends up and away from the water receptacle forming a roof or lid to the device. In addition, the lid is a telescoping lid which is to say it consists of multiple segments that slide into one another so that the lid can be opened in stages. The lid can be fully opened to allow a pet free access to the water in the water receptacle, but it can also be partially opened such that a portion of the lid folds back allowing some access to the water receptacle. When the lid is partially opened, the lid can act as a back splash or similar device to avoid water being slopped or thrown out of the device. For example, a pet owner might seat their animal in the passenger seat of the vehicle, open the lid to the device halfway with the closed portion of the lid closest to the driver and allow the pet to drink out of the open side of the device without splashing water onto the driver.

These and other advantages will be more apparent in light of the detailed description below. The device can be made of any number of durable materials and the inventor anticipates the market will support different versions of this device made of materials of varying strength to produce cheaper more flexible versions and more expensive durable versions.

### BRIEF DESCRIPTION OF THE SEVERAL VIEWS OF THE DRAWINGS

FIG. 1 is a perspective view of the base and bowl of the device with the lid removed;

FIG. 2A is a cross-sectional view of the device with the lid in place on the bowl;

FIG. 2B is a cross-sectional close-up view of the area of FIG. 2A that is circled;

FIG. 3A is a front plan view of the device with the lid and handle attached;

FIG. 3B is a side plan view of the device with the lid and handle attached and

FIG. 4 is a perspective view of a second embodiment of the device showing the base and bowl of the device with the lid removed.

### DETAILED DESCRIPTION OF THE INVENTION

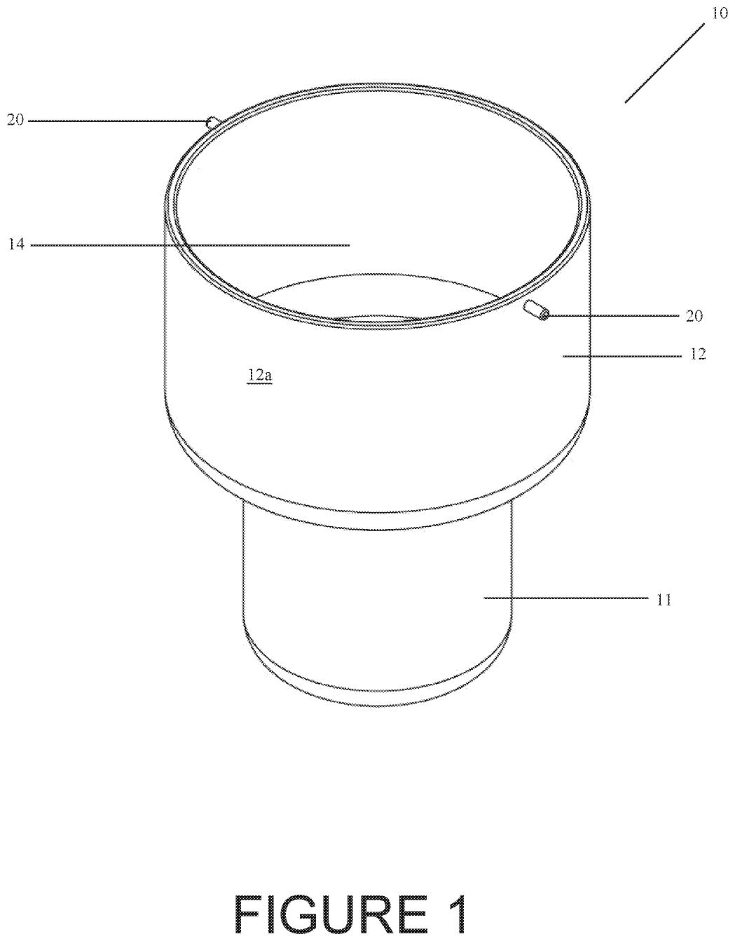

Referring now to the invention in more detail, FIG. 1 shows a preferred embodiment of the base 11 or stand of the device 10 joined to the water receptacle or bowl 12. The base 11 is configured to fit into a standard cup holder in an American passenger vehicle (not shown). Skilled artisans can readily appreciate that the stand can be reshaped to fit into virtually any desired space or holder, but the anticipated best mode of this device has a stand that is roughly cylindrical in shape and is sized to fit into a cup holder. As previously discussed, the stand can be hollow, solid or any combination thereof.

FIG. 1 also shows the bowl 12. In this embodiment, the bowl 12 is a cylindrically shaped, cup-like enclosure that is attached to or integrated into the base 11. The bowl 12 is formed by at least one wall 12a extending up and away from the base 11 of the device 10. Other embodiments can have a detachable base 11 that is not integrated or permanently attached to the bowl 12. The base 11 can communicate with a cavity 14 formed by the wall(s) 12a of the bowl 12 or not. The base 11 can be a solid piece that does not hold any fluid or air or it can be hollow.

Finally, FIG. 1 shows the hinge 20. In the embodiment shown in FIG. 1, the hinge 20 includes of one or more protrusions that extend laterally away from an outer surface of the walls 12a of the bowl 12 portion of the device 10. These protrusions are sized and positioned, i.e. configured, to insert into holes (not shown) that are located on a portion of the lid (not shown) thereby holding the lid (not shown) onto the rest of the device 10 and allowing other structures to rotate around the protrusions like a hinge.

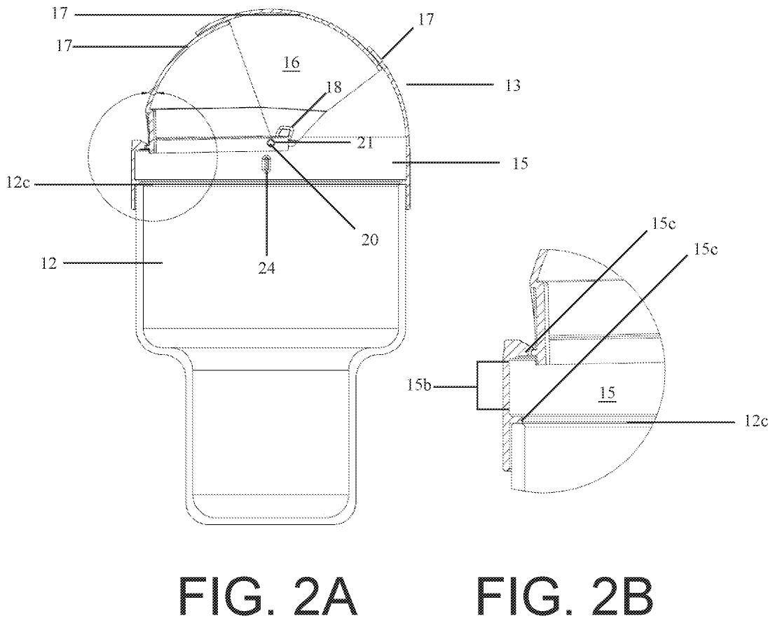

FIGS. 2A and 2B show the device with a convex or curved, retractable lid 13 attached to the bowl 12. FIG. 2B is a close-up of the portion of FIG. 2A that is circled. A skilled artisan will appreciate that the lid 13 need not be a curved or convex structure, but can be a flattened structure as well, without affecting the functioning of the device. In this embodiment, the retractable lid 13 is a telescoping lid made in part of a plurality of segments 17, a fastening ring 15 and a hinge 20. The movement of the segments 17 of the telescoping lid 13 is accomplished by operably connecting each one of them to a hinge 20 or other pivot point located on the lid 13 or some other portion of the device. The embodiment in FIG. 2 shows the hinge 20 is featured on an outer surface 16 of the lid 13. The protrusions that make up the hinge 20, can extend away from the lid 13 in two directions. The protrusions extending outward and away from the fastening ring 15 serve to allow a handle (not shown) to be attached to the device 10 and to help secure the lid 13 to the bowl 12. The hinge 20 can also extend into the interior or cavity 14 of the device 10. The segments 17 of the lid 13 attach to the portion of the hinge 20 that extends toward the interior of the device 10 thereby allowing them to pivot around the hinge 20. It is also possible to provide the handle (not shown) with a different attachment point 24 on the fastening ring 15 such as the alternate attachment point 24 shown in FIG. 2A.

In this embodiment, the fastening ring 15 is attached to an outer surface 12b of the walls 12a of the bowl 12. The fastening ring 15 has a groove 15b defined by two protrusions 15c that engage the outer surface of the walls 12b of the bowl 12. Specifically, one of the protrusions 15c defining the groove 15b of the fastening ring 15 inserts into or otherwise engages with a groove 12c that is featured on the outer surface 12b of the walls 12a of the bowl 12. The protrusion on the other side of the groove 15b on the fastening ring rests on or otherwise engages and secures to the upper edge of the bowl 12.

In this and other embodiments, the hinge or pivot point 20 is a protrusion or set of protrusions that is/are configured to fit through a hole 21 or set of holes featured by the lid 13 or fastening ring 15. In preferred embodiments, the hinge 20 is located on a portion of the base 11 or bowl 12 over which the fastening ring 15 is positioned. These same embodiments feature the holes 21 in the fastening ring 15 through which the hinge 20 extends. A skilled artisan can appreciate that the positioning of the hinge and holes 21 can be varied while still producing the same functionality. For example, the fastening ring 15 can feature these protrusions on an exterior surface or an interior surface and the lid segments 17 which can be attached to and rotate around these protrusions that make up the hinge 20.

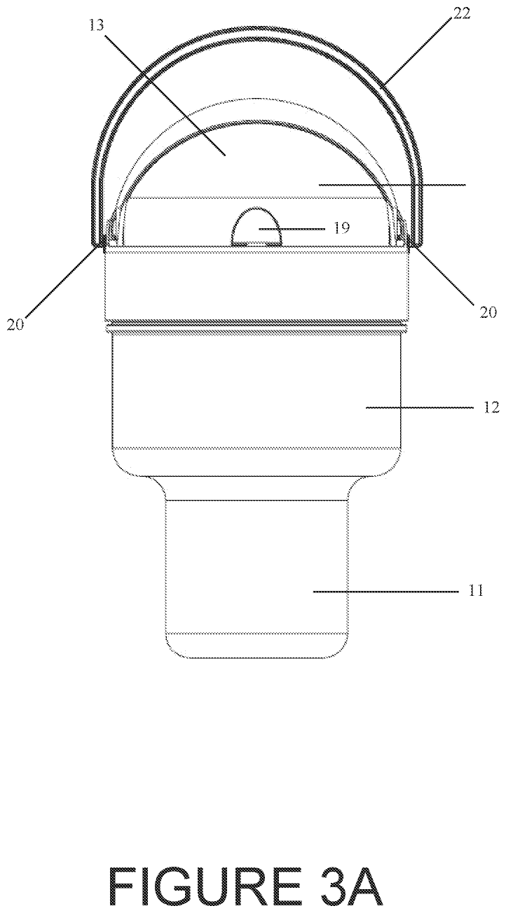

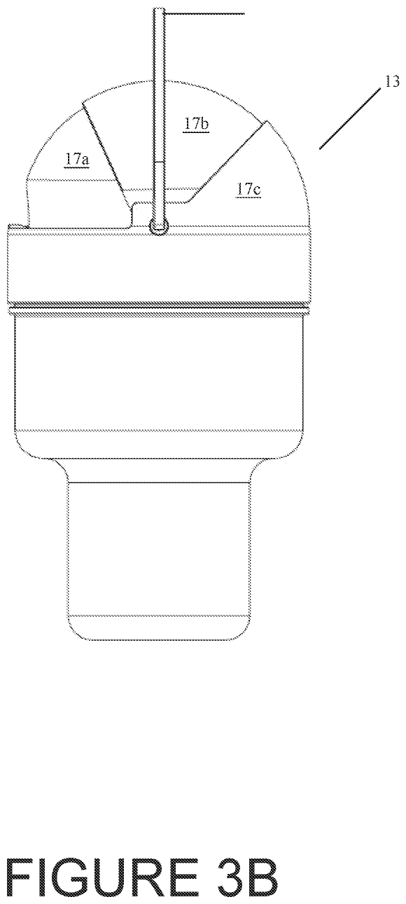

FIGS. 2A, 2B, 3A and 3B show the segments 17 of the telescoping lid 13 are positioned one in front of the other when the lid 13 is closed. The segments 17 are spaced apart from each other to allow movement. Specifically, this embodiment features three segments 17a, 17b and 17c. The first segment 17a is the smallest segment and is sized and positioned to be moved underneath the second segment 17b of the lid 13. In preferred embodiments, the second segment 17b of the lid 13 has an inner surface that features protrusions, tabs or stops 18 that are positioned to stop the first segment 17a from moving any further backward when the lid 13 is opened (see FIG. 2A). When the user desires to open the lid 13, they slide the first segment 17a back such that it is tucked or positioned underneath a second, adjacent segment 17b. The movement of the first segment 17a is stopped when the first segment 17a encounters a tab 18, set of tabs or stops inside the lid 13 and preferably located on the second segment 17b. Similarly, the second segment 17b together with the first segment 17a can be moved backwards underneath a third segment 17c. As above, the third segment 17c features one or more tabs 18 that are positioned to stop the second segment 17b (and thus the first segment 17a) from moving any further backward when the lid 13 is opened. In some embodiments, the first, second and third segments 17a, 17b and 17c can slide back further such that they are positioned along the inside surface of the bowl 12 thereby completely opening the bowl 12. However, in preferred embodiments, the segments 17 of the lid 13 slide backwards until they come to rest on the fastening ring 15 thereby forming a wall or barrier between the rest of the device 10 and anything located on the other side of the device 10. This configuration may be very beneficial for pet owners in that the lid 13 can form a barrier between the pet and the owner when their pet is drinking from the device 10.

FIGS. 3A and 3B show an embodiment of the device featuring an optional handle 22. In this embodiment, the handle 22 is attached to the protrusions that form the hinge 20. However, other embodiments can feature a handle 22 attached to a different portion of the device 10 including the base 11 or the bowl 12. In addition, some embodiments also have a catch, handle or shelf 19 built into the outer surface of one of the segments 17, preferably the first segment 17a to assist the user in grasping and manipulating a segment 17 of the lid 13.

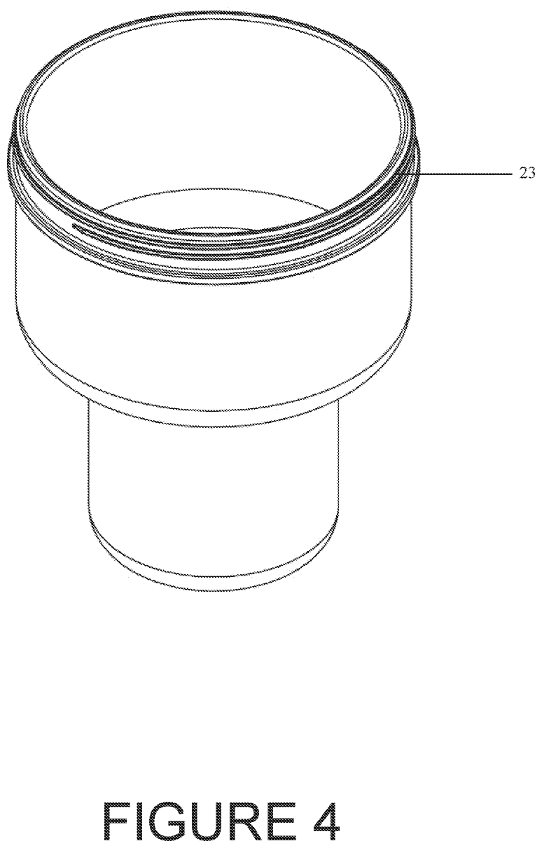

FIG. 4 shows another embodiment of the device 10. The embodiment in FIG. 1 has a fastening ring 15 that snaps onto the outer surface of the bowl 12. The embodiment shown in FIG. 4 includes complementary threads 23 on an exterior surface of the bowl 12 and an interior surface of the fastening ring (not shown) that allow the fastening ring 15 and this the lid 13 to be screwed onto the bowl 12. FIG. 4 shows an embodiment that lacks protrusions on an outer surface 12b of the walls 12a of the bowl 12. In these embodiments, the hinge 20 is featured on a portion of the lid (not shown).

In use, the device 10 is placed into a cup holder or other appropriate receptacle, the lid 13 is opened by pushing each segment 17 back underneath the adjacent segment 17 until the lid 13 and bowl 12 are either partially or fully opened. The user then pours water or other fluid into the bowl 12, filling it as full as desired and then closes the lid 13 by pushing adjacent segments 17 forward such that they are not longer positioned one underneath the other. When the user wants to provide their pet with hydration, they simply open the lid 13 to the desired position and allow them to drink. Because one of the main anticipated uses of the device is for use in a moving vehicle, the lid 13 can be positioned such that it forms a wall or barrier between the pet and their owner while the pet is drinking from the device 10 located in a cup holder of a vehicle.

Please note, any dimensions and/or measurements noted on the figures are merely for illustrative purposes as the size and dimensions of the device can be altered as needed.

The advantages of the present invention include, without limitation, the ability to provide a pet with a means of hydration with a device that is configured for use in a motor vehicle. In addition, the device is suitable for transporting water for one's pet regardless of the positioning of the device. In addition, the device allows the user to have a barrier between themselves and the animal when it is drinking to decrease the potential for splashing on the pet owner.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A portable watering station comprising:
a base;
an enclosure formed by at least one wall extending away from the base; and
a retractable lid.

2. The portable watering station of claim 1 wherein the base is configured to fit into a standard cup holder.

3. The portable watering station of claim 2 wherein the retractable lid is a telescoping lid having a plurality of segments and at least one of the plurality of segments is sized and positioned to slide underneath a remainder of the plurality of segments.

4. The portable watering station of claim 3 wherein the segments of the telescoping lid slide back and rest on the fastening ring.

5. The portable watering station of claim 3 wherein the plurality of segments are attached to at least one protrusion featured by the fastening ring and wherein the plurality of segments are configured to rotate at least partially around the at least one protrusion.

6. The portable watering station of claim 3 wherein the plurality of segments features one or more tabs that are positioned to stop the adjacent tab from moving in one direction.

7. The portable watering station of claim 3 further comprising a groove formed by two protrusions wherein at least one of the protrusions engages with a second groove featured by an outer surface of the bowl.

8. The portable watering station of claim 3 further comprising a fastening ring attached an outer surface of the wall of the enclosure by engaging complementary threads on the fastening ring and outer surface of the wall.

9. A portable watering station comprising:
a base configured to fit into a cup holder;
at least one wall extending away from the base forming a cavity;
a hinge;
a retractable lid made of a plurality of segments operably connected to the hinge such that the plurality of segments can rotate at least part of the way around the hinge.

10. The portable watering station of claim 9 wherein the plurality of segments comprises a first segment and at least one other segment that features a stop on an interior surface; wherein the first segment is positioned to slide underneath the at least one other segment as it rotates around the hinge and to stop rotating when it contacts the stop on the interior surface of the at least one other segment.

11. The portable watering station of claim 10 further comprising a fastening ring attached to an outer surface of the at least one wall.

12. The portable watering station of claim 10 wherein the fastening ring features threads on an inner surface of the fastening ring that are complementary to threads featured on an outer surface of the at least one wall.

13. The portable watering station of claim 11 further comprising a first groove formed by two protrusions on the fastening ring wherein at least one of the protrusions engages with a second groove featured by an outer surface of the bowl.
